(19) United States
(12) Patent Application Publication
(10) Pub. No.: US 2005/0273247 A1
(43) Pub. Date: Dec. 8, 2005

(54) Methods to move plural sets of transportation objects through a single route in uniformed skip-stop patterns based on scheduling described by linear function equation

(76) Inventors: Vitaliy Lyakir, Brooklyn, NY (US); Alla Litovchenko, Needham, MA (US); Dmitry Denikin, Bethlehem, PA (US)

Correspondence Address: ALLA LITOVCHENKO, 855 GREAT PLAINS AVENUE, NEEDHAM, MA, 02492, US

(21) Appl. No.: 11/203,572

(22) Filed: Aug. 12, 2005

Related U.S. Application Data
(63) Continuation of application No. 10/443,170, filed on May 23, 2003.

(51) Int. Cl. G08G 1/00

(52) U.S. Cl. 701/117; 340/994

(57) ABSTRACT

Transportation system optimization with scheduling method whereas vehicles movement through a single route in skip-stop fashion due to application of algorithmic functions to uniform vehicles movement with extra benefits from multiple resources availability.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

This is a continuation in part of the patent application Ser. No. 10/443,170 filed at May 23, 2003 to substitute the original filing.

### BACKGROUND OF THE INVENTION

The invention pertains to the method of transportation scheduling. In particular, the invention pro-vides substantially optimal vehicle schedules with respect to operation cost resulting from decrease in the energy loss caused by unnecessary vehicle acceleration.

A reason for new scheduling method comes from the fact that present transportation scheduling method tend to reflect mainly the topography of passengers' distribution. But passengers are only the one element of system, shearing mutual sequences coming from other members' performance. Heretofore, all transportation system members, including passenger, sheared negative impact from technical disadvantages occurred in other parts of system.

By now, daily trips grow too long, suggesting passengers to switch into individual transportation in an attempt to reach their destination faster. Larger number of stations emerged on a transportation route cause more difficulty keeping a service schedule uninterrupted with emergencies. Therefore, a transportation unit speed keeps being increasingly non-constant. But reducing in stations quantity to obtain a substantially longer run between stations will case difficulty to entering a service vehicle.

In the central part of a large city a busy parts of transportation routes contain merged areas and have shorter distances between stations. Such an area tends to accumulate more vehicles together and causes them not to fit in at a certain time. These inequalities in distance between stations in different city areas and in vehicle speed therefore cause break in a time approximation schedule. Then rush-hour traffic is flooded with its famous jam.

The major disadvantage for public transportation is the rush hours traffics' slow down. The need to attend every station on a route makes travel time increasing Here the curious situation occurred: our transportation vehicles run faster at noon and at night, when fewer passenger need to hurry up. On the other hand, longer distances between stations make entering a service vehicle difficult to customer. Walking distances are usually too long in personal perceptions, but vehicle run between local stations usually is too short in order to achieve and maintain an allowed maximum speed. This is a major dilemma in transportation topography.

Considering existing scheduling methods' disadvantages in general, running in the Express fashion passenger transport unable to cover many important destinations between hubs, otherwise multiple local stops inhibiting a service speed.

Heretofore, the service speed is slowing down and travel cost is rising up. Said financial and technical disadvantages often overweight the economical convenience for both, passenger and provider.

An idea to save energy by employing various skipping-of-stations methods for transportation service was never implemented as systematic replacement for the Local Service on an overall basis. One of a few reasons why known methods have not been effective is an attempt to utilize both Local (stop at every station) and Skip -Stop services on the same path and to skip stations randomly. Common practice to employ a random order of Skip-Stop Service topography based only on temporal and load demand leads to random mode of stops scheduling resulting in particular difficulty to access a service vehicle. Such practices lift a cost of operations on passenger transport of the plural kind, the public, privately owned and of mixed ownership. However, the Skip-Stop service can replace said Local service if all vehicles will accessible in accordance with existing service topography at convenient time.

Another example is numerous Rail Road Scheduling Systems as decrypted in United States Patents in particular under U.S. Pat. Nos. 5,177,684 and 5,623,413. Both patents in fact approach the scheduling method differently than the present method. In particular, by applying its original algorithms for improving service on a single overloaded station, they make their achievements accordingly.

However the previous art (The Implicit Enumeration Algorithm, The Lower Bound-Based Exact Pruning Algorithm, The Accelerated Heuristic Lower Bound-Based Algorithm, etc) does not targeting benefits from scheduling methods, where different sets of vehicles to serve a single route on a skip-stop movement pattern where every vehicle is following the same algorithm mode resulting in improvement of the vehicles cumulative capacity following after increase of the operation speed, caused by minimized demand in inertia factor.

The Standard City Traffic Statistical Estimations recognize an energy loss by various transportation objects due to vehicle inertia factor caused with its acceleration after frequent stopping and which is running at an average from 40% to 80% of BTU (fuel).

### BRIEF SUMMARY OF INVENTION

The request for replacing comparatively inefficient in respect to time cost and economic resources the passenger local service with the uniformed skip-stop service is based on the idea to benefit from minimization of vehicle acceleration to get the same result for energy lost heretofore or otherwise to get an increase in speed and in cumulative passenger capacity of transportation equipment accordingly.

To compete with private cars with more success, City Transportation Government is encouraged to accept two types of the short-distance service transportation disregarding the form of its ownership. One to be buses on a Local Service schedule to attend every requested by customer station on a route and to run during non-rush-hours time. Second to be buses running during rush hours and a city train, performing both a skip—stop fashion service where each particular vehicle attends only designated stations and passing by all other stations. These vehicles are to be named “Liners”. These Liners' faster moving resulted in significant savings on resources. Saving on inertia lost is expected due to stops attendance by particular vehicle to be minimized in quantity and therefore required afterwards acceleration become decreased in demand. Additional savings can be made by reducing in number the serving vehicles the way so remaining transportation units of identical load capacity are able to move the same volume of passenger load. This can result from moving at higher speed due to stops partial elimination and decreasing theretofore in traveling time and in reloading time.

A general schema is to employ a transportation system where all stations on each route are served with vehicles scheduled to stop in different stations for passenger service and having few (or non) mutual stops or, alternatively, a connection vehicle for interfering of these vehicles with each other.

When transportation system employed with absence of mutual stops and connection vehicles for interfering all stations on a route (existed or newly built) to be located within a walking distance from each other, which preferably is not exceeding 10 to 20 minutes.

Accordingly, it is an object of the present invention to obviate the above deficiencies of known systems and to provide a novel system and method for scheduling the movement of passenger vehicles through a One-route Transportation System.

It is another object of the present invention to provide a novel system and method for optimizing the movement of passenger vehicles through a One-route Transportation System.

It is yet another object of the present invention to provide a novel system and method for optimization with consideration of energy savings, and operations cost.

These and many other objects and advantages of the present invention will be readily apparent to one skilled in the art to which the invention pertains from a perusal of the claims, the appended drawings, and the following detailed description of the preferred embodiments.

As is readily apparent, the system and method of the present invention is advantageous in several aspects.

By avoiding economically disadvantaged stops and acceleration afterwards with all named above classes of passenger vehicles, certain amounts of energy is saved.

Due to decrease in serving stops demand, the ability of passenger vehicles to speed through stations and a greater volume of service is achieved without additional resources spending. This volume of service further we will call The Cumulative Capacity.

By having passenger vehicles working faster, fewer vehicles and fewer drivers is employed to perform the same required amount of service. Alternatively, physical parameters of passenger vehicles are reduced instead.

In various transportation systems employing electric vehicles an additional savings achieved by lowering the amount of energy in the electric circuit in case to employ shorter trains instead of decreasing the vehicles quantity on line.

By having a vehicles' movement pattern uniformed the equal temporal convenience for every passenger is achieved.

By running vehicles on uniformed movement pattern from each particular station on a route faster, the standard travel time for a customer is decreased.

### BRIEF DESCRIPTION OF THE SEVERAL VIEWS OF THE DRAWINGS

FIG. 1 is a diagram that illustrates Method 1 with graphical representation of a typical scheduling for two Liners on the same path, having no mutual stops for intersection.

FIG. 2 is a diagram that illustrates Method 1 with graphical representation of a typical scheduling for three Liners on the same path, having no mutual stops for intersection.

FIG. 3 illustrates Method 2 with graphical representation of a typical scheduling for two Liners, having no mutual stops, and Shuttle on the same path for service intersection.

FIG. 4 illustrates Method 2 with graphical representation of a typical scheduling for three Liners, having no mutual stops, and Shuttle on the same path for service intersection.

FIG. 5 is a diagram that illustrates Method 3 with graphical representation of a typical scheduling for two Liners serving different stations on the same path and having additional mutual stops for intersection with each other.

FIG. 6 is a diagram that illustrates Method 3 with graphical representation of a typical scheduling for three Liners serving different stations on the same path and having additional mutual stops for intersection with each other.

### DETAILED DESCRIPTION OF THE INVENTION

A present attempt is to optimize transportation systems' functionality by faster service. A sequence of stations' attendance by vehicles to be uniformed and scheduled accordingly an algorithmic function equations.

The request for replacing or combining an inefficient and expansive transportation local service with uniformed skip-stop service is satisfied with three methods as described below.

For every method all stations are existed on a single route and are served with the moving in the same direction consequent sets of transport units (Liners) all having no mutual stops (except Hubs in the Method 3).

Every member of these sets is due to skip (not attend) an equal quantity (z) of consequent stations between two attended neighboring stations. (Here “z” is any natural number: z>0;) The quantity of stations due to skip does not to be determined by the methods of disclosure but only depends on existing stations topography, vehicles speed, etc. This step is to be designed by a service provider to achieve any desirable distance between stops.

All methods are started with setting up a quantity of sets of Liners (L) in a service line, which to be equal to quantity of Liners in a single cycle of Liners' movement. A service cycle of Liners' movement corresponds to a part of a route, containing stations attended by each member of every set, accordingly their designations, only one time. When one unit of each set of vehicles entered a service line, cycles are starting with the closest station attended by members of the one vehicle set and are ending at the station located on transportation route before the station attended by members of the same vehicle set second time. A service route is consists with consequent cycles of vehicle movement.

Quantity of sets of Liners (L) defines the number of stations in a single cycle, both, attended and skipped. Each vehicle is to attend one station during a cycle and to pass by the all others (z): L=z+1;

When L=3, than a service cycle is every three stations, where skipped are every two stations (z=L−1=3−1=2) and one to be attended. Each vehicle of these three sets of Liners attending a different station in a cycle. Consequent service cycles on a route constitute a service line where all stations are attended by a vehicle belonging to every set only once during each cycle. 20 full cycles on a route constitute total stations quantity as 20L plus stations at both ends of this route which quantity is not enough to constitute a cycle.

At all methods, accordingly set up relation between a movement pattern of station attendance by vehicles as a function of repeated cycles of stations coordinates, each station position at the stop sequence to be determined as root (“y”) of the standard linear function equation (y=bx+c), where:
variable's coefficient “b” represents a part of a service route containing stations constituting one service cycle (which for Method 1 is equal to a total quantity of Liners' sets): b=L; [L(min)=2;]
variable “x” represents a number of each consequent cycle of liner vehicles movement and is defined by the sequence in the set of whole numbers “W” [W=0,1,2, . . . W(max.)];

Accordingly, first cycle: W1=0; next cycle: W2=1, . . . , last cycle: W(max);

Total quantity of stations on a path: LW1+LW2+ . . . LW(max)=L[W1+W2+ . . . W(max)];

For Method 1 each free member “c” corresponds to a particular set of Liners in a single vehicles movement cycle accordingly scheduled sequence of stations attendance by vehicles: (1,2 . . . L);

A free member “c” is defined by a sequence in the set of natural numbers “N” (1,2,3, . . . L) between “1” and “L” including both.
c(min)=1; c1=2; . . . c(max)=L; or alternatively:
c(max)=L; c1=c(max)+/−1/; c2=c1+/−1/; c3= . . . c(min)=1;

A random mood for sequences of stations attendance are available if do not depriving from the set up definition of vehicles' movement cycles constituting a service route.

For each movement pattern the smallest free member “c(min)” defines the beginning of a cycle [c(max)=L;] and the largest free member “c(max)” defines the end of a cycle [c(max)=L;]

A position of particular station in a sequence of attendance by service vehicle on a route is a sum of numerical position of last station of preceded cycle [LW(last)] and numerical position in a cycle of the vehicle set attending this station (N): y=bx+c=WL+N;

At Method 2 two or more groups of vehicle sets can be employed on the one path performing connections for each other between different sets of Liners, typically on the same route or otherwise connecting parallel and intersecting passes. One of these alternative sets can have incomplete group of vehicles sets (as little as one set which is to pass by all but one stations in its cycle) and further to be called a “Shuttle”.

The number of stops skipped by Shuttle is not equal to “z”: z−k<z<z+k;
where “k” is any natural number [(z−k)min=0; if no station are skipped].

Shuttles' quantity in a cycle: L(shuttle)=z+/−k/+1;

Shuttles' sequence between Liners to be set up in any useful to service provider relation with Liners quantity and therefore depriving from the meter of the methods of disclosure. The attendance of stations on a route by shuttle vehicles to be uniformed in its movement pattern as follow:

By set up definition a sequence of Shuttle stops at a service line: y=bx+c; where: b=L; x=W; “c” is defined by sequence of whole numbers “w” between 0 and (L+/−k/), including both.

Then: Y=W(L+/−k/)+w; or: Y=W(z+/−k/+1)+w; (No correlation between “w” and “W” is necessary.)

When shuttle vehicle attending every station, than: (z+/−k/+1)min=1; than location of stations attended by shuttle at every cycle: Y=W+w;

When all shuttle vehicles belong to one set, than: c=0; accordingly, a location of stations at every cycle: Y=W(z+/−k/+1);

Alternatively, at Method 3 all stations on a route are served solely with sets of Liners having occasional mutual stops in hubs in addition to stops at stations being served separately.

Accordingly set up relation between quantity of station due to skip (z) and quantity of Liner sets (L): L=z+1;

By set up definition position of the each particular station on a service line is one of multiple roots of standard linear equation: y=bx+c;

The value of the variable (x) represents numbers of cycles in their sequence on a route, (as per Method 1): x=W;

Alternatively, at Method 3 the value of the variable's coefficient (b) which is representing quantity of stations constituting each cycle, is consisting with total quantity of stations attended during a cycle by members of each Liners set separately (L) and quantity of a Hub stations (H) in said cycle to create extended cycle: b=L+H;

When quantity of hubs in every extended cycle is 1 (H=1;), than: b=L+1;

In this method, value of the free member “c” coordinates with position of corresponding station in the each cycle and defined by sequence of whole numbers (w=0,1,2, . . . L); as per Method 1.

At the each first station in a cycle: c(min)=0; for all last stations in cycles: c(max)=L+H;

Accordingly, the number of each station in the sequence of vehicle attendance at every cycle: y=W(L+H)+w;

No correlation between “x” and “c” represented with “W” and “w” is necessary.

When each cycle have only one hub, than: y=W(L+1)+w; or: y=W(z+2)+w;

When a service line is containing different quantities of hubs in the particular cycles (including hubs absence: H=0;), than value of “H” (at: y=W(L+H)+w;) in each different cycle is determined by a corresponding quantity of hubs accordingly.

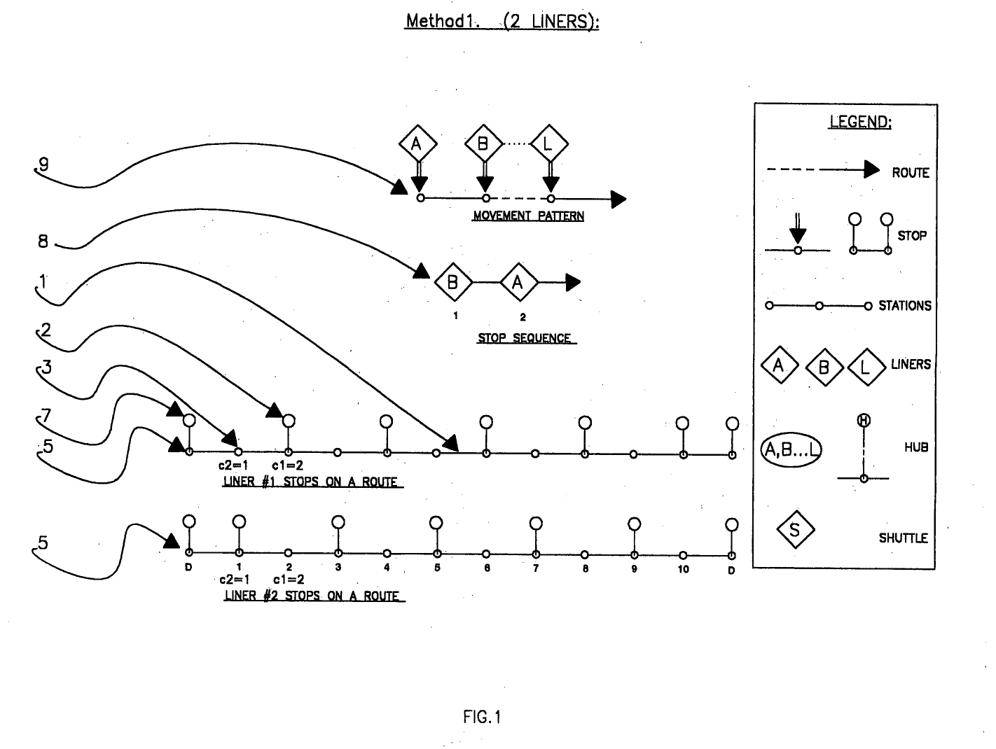

On FIG. 1-6 examples of scheduling are provided.

Legend: 1-route; 2-stop; 3-station; hub; 5-liner; 6-shuttle; 7-vehicle depot; 8-stops sequence schedule; 9-graphical representation of vehicle movement.

On FIG. 1 Method 1 is introduced as schema of uniformed consequent one-way movement of vehicles along a route (1) with multiple stations (2). All stations are served by alternative vehicle sets of two (A and B) Liners (5), where each vehicle due to skip every other station (z=1) between stops (3).

L=z+1=1+1=2; all stops numbers are at: y=bx+c; or accordingly definitions: y=WL+N=2W+N;
The first liner (A) have first run in a cycle larger than the second liner (B): c1=c(max)=L=2; to stop at: y1=2W+2;
Second liner (B), accordingly: c2=c(max)−1=2−1=1; to stop at: y2=2W+1;
At cycle 1 (W1=0;) of this movement pattern the stops are at stations number:
y1=2×0+2=2; for A, and y2=2×0+1=1; for B.

At cycle 2 (W2=1;) of this movement pattern the stops are at stations number:
y1=2×1+2=4; for A, and y2=2×1+1=3; for B.

Similarly at W3=2; y1=6; y2=5; at W4=3; y1=8; y2=7;

Liner A stops at stations: 2,4,6,8 . . . y1(max); Liner B stops at stations: 1,3,5,7 . . . y2(max);

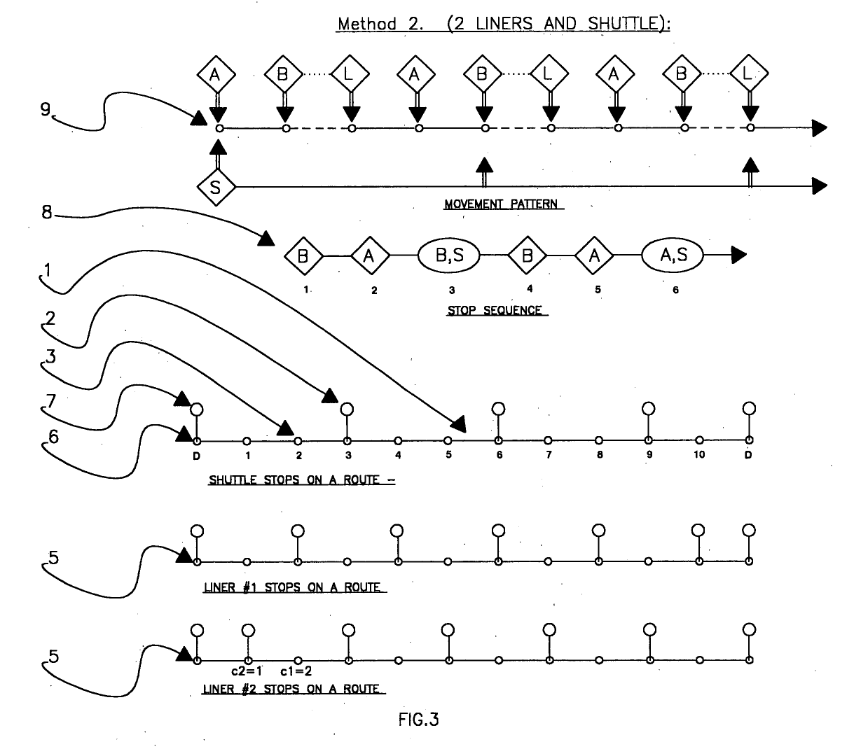

On FIG. 3 Method 2 is introduced as the identical to FIG. 1 schema of liners' movement pattern which is adjusted with shuttle service schedule (6) for interconnection between liners (5) of different sets.

All shuttle stops (3) except vehicle depot (7) become hubs (4) to allow passenger switching between shuttle and one of liners (A and B).

These hubs are at stations number Y=bx+c; Y=WL+w; k=1; L=z+k+1=1+1=3; c(max)=w=0; (alternative vehicle movement pattern is absent); than: Y=3W+0=3W;

For W1: Y1=3×0=0; for W2: Y2=3×1=3; similarly: Y3=6; Y4=9; . . . Y(max);

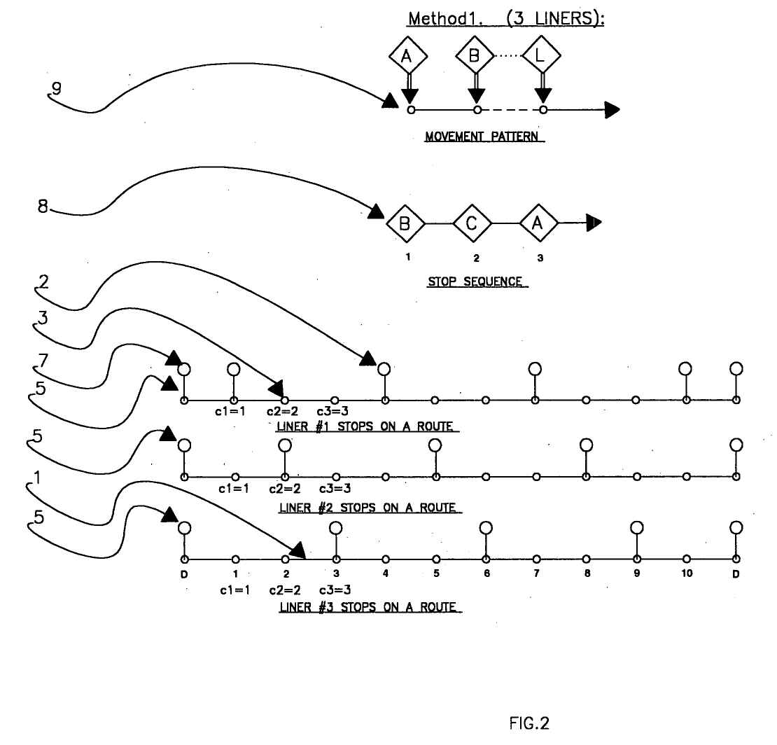

On FIG. 2 Method 1 is introduced as schema of uniformed consequent one-way movement of vehicles along a route (1) with multiple stations (2). All stations are served alternatively by vehicle sets of three (A, B, C) liners (5) each, which due to skip every two station (z=2) between stops (3).

All stops numbers are: y=bx+c; or: y=WL+N=3W+w; (if L=z+1=2+1=3;)

First liner (C) have largest run: c3=c(max)=L1=3; to stop at: y1=3W+3;

Second liner (B): c2=c(max)−1=3−1=2; to stop at: y2=3W+2;

Third liner in set (A): c1=c2−1=2−1=1; to stop at: y2=3W+1;

At cycle 1 (W1=0;) of a liners' movement pattern stops are at stations number:
y1=3×0+1=1; for A, y2=3×0+2=2; for B, y3=3×0+3=3; for C.

At cycle 2 (W2=1;) of a liners' movement pattern stops are at stations number:
y1=3 x1+1=4; for A, y2=3 x1+2=5; for B, y3=3 x1+3=6; for C.

Similarly at W3=2; y1=7; y2=8; y3=9; at W4=3; y1=10 . . . etc.

Liner A stops at stations: 1,4,7,10 . . . y1(max);

Liner B stops at stations: 2,5,8 . . . y2(max);

Liner C stops at stations: 3,6,9 . . . y3(max);

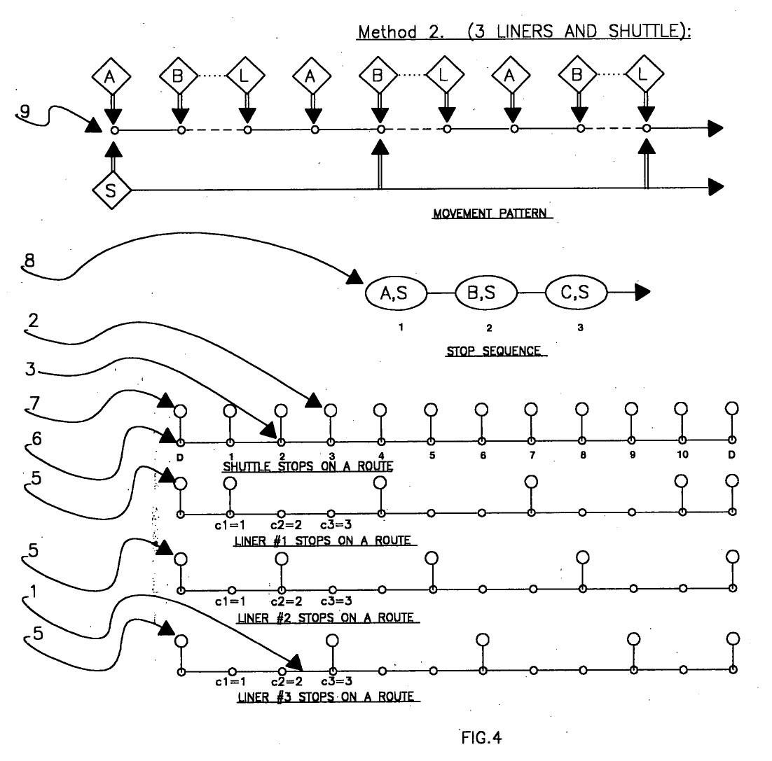

On FIG. 4 Method 2 is introduced as the identical to FIG. 2 schema of liners' movement pattern which is adjusted with shuttle service schedule (6) for interconnection between liners (5) of different sets.

All shuttle stops (3) allow passenger switching between shuttle and one of liners (A,B,C).

These stops locations are at stations number: Y=bx+c; Y=WL+w; k=1; L=z−k+1=2−1=1; c(max)=w=0; (alternative vehicle movement pattern is absent); than: Y=1W+0=W;

Y1=0; Y2=1; Y3=2; Y4=3; . . . . Y(max);

Although in FIGS. 1 through 4 (Methods 1 and 2) each schema utilizes a different schedule corresponding to quantities of employed vehicle sets, presence or absence of Shuttle service, all movement patterns for vehicles on transportation line have similar method described by the same formula provided in specification previously.

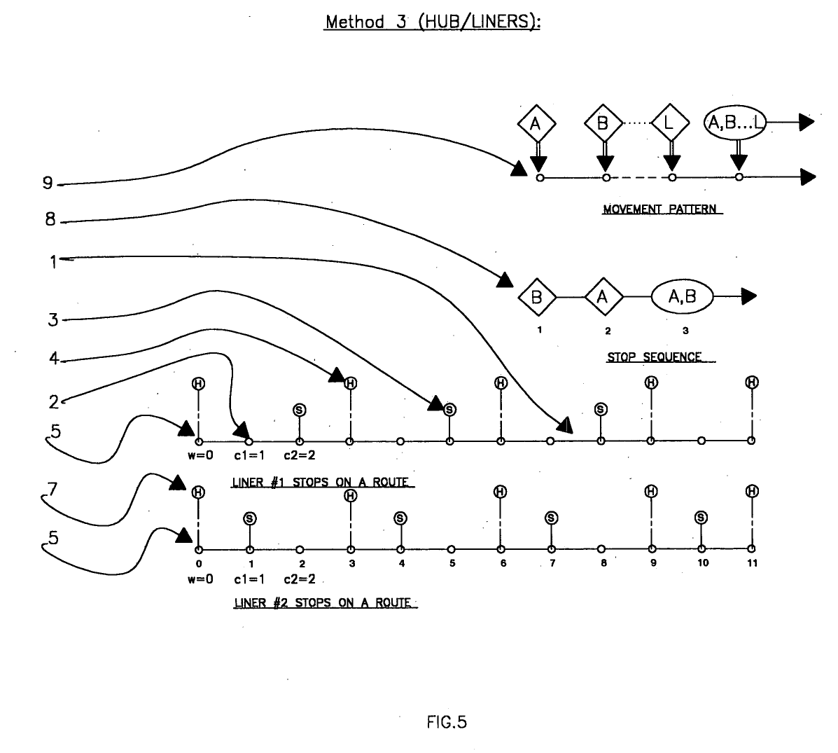

On FIG. 5 Method 2 is introduced as schema of uniformed consequent one-way movement of vehicles along a route (1) with multiple stations (2). All presented stations are served alternatively with vehicle sets of two (A and B) liners (5) each, by skipping every one station (z=1) between stops (3) and hub stations (7) for mutual stops.

All stops numbers are: y=bx+c; or: y=W(L+1)+w=3W+w; (if L=z+1=1+1=2;)

First liner (A) have largest run: c1=c(max)=L=2; to stop at: y1=3W+2;

Next liner in set (B): c2=c(max)−1=2−1=1; to stop at: y2=3W+1;

All hubs have same location pattern, where: w=0; and stops are at: Y=3W+0=3W;

At cycle 1 (W1=0;) of a liners' movement pattern stops are at stations number:

Y=3W=0; for hub, y1=3×0+2=2; for A, y2=3×0+1=1; for B.

At cycle 2 (W2=1;) of a liners' movement pattern stops are at stations number:

Y=3W=3; for hub, y1=3×1+2=5; for A, y2=3x1+1=4; for B.

Similarly at W3=2; Y=6; y1=8; y2=7; W4=3; Y=9; y1=11; y2=10; . . . etc.

Hub stations number: 0,3,6,9 . . . Y(max);

Liner A stops at stations: 2,5,8,11 . . . y1(max); Liner B stops at stations: 1,4,7,10 . . . y2(max);

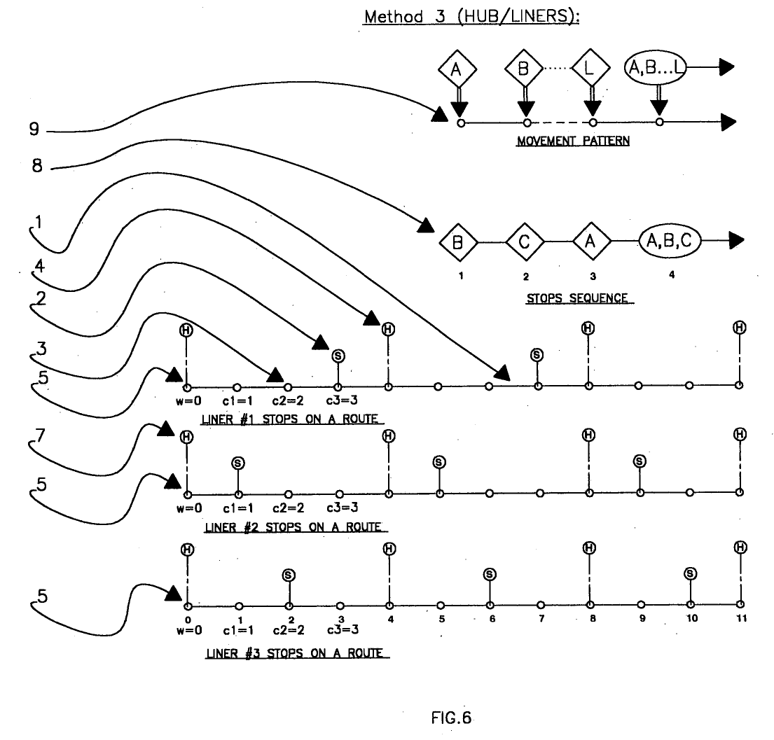

On FIG. 6 Method 3 is introduced as schema of uniformed consequent one-way movement of vehicles along a route (1) with multiple stations (2). All presented stations are served alternatively with vehicle sets of three (A, B, C) liners (5) each, by skipping every two station (z=2) between stops (3) and hub stations (7) for mutual stops.

All stops' location are at: y=bx+c;
or: y=W(L+1)+w=4W+w; (if L==z+1=2+1=3;)

First liner (A) have largest run: c1=c(max)=L=3; to stop at: y1=4W+3;

Next liner in set (B): c2=c3−1=2−1=1; to stop at: y2=4W+1;

Last liner (C): c3=c(max)−1=3−1=2; to stop at: y3=4W+2;

All hubs have same locations' pattern, where: w=0; and stops are at Y=4W+0=4W;

At cycle 1 (W1=0;) of a liners' movement the stops are at stations number:

Y=4W=0; for hub, y1=4×0+3=3; for A, y2=4×0+1=1; for B,
y3=4×0+2=2; for C.

At cycle 2 (W2=1;) of a liners' movement stops are at stations number: Y=4W=4; for hub, y1=4 x1+3=7; for A, y2=4 x1+1=5; for B, y3=4 x1+2=6; for C.

Similarly at W3=2; Y=8; y1=11; y2=9; y3=10; . . . etc.

Hub stations number: 0,4,8 . . . Y(max);

Liner A stops at stations: 3,7,11 . . . y1(max);

Liner B stops at stations: 1,5,9 . . . y2(max);

Liner C stops at stations: 2,6,10 . . . y3(max);

A combinations and modifications of disclosed methods available as it may convenient.

On FIG. 1-6 following schedules are represented at vehicles' stop sequence (8) and movement schema (9):

Legend:

| | |
|---|---|
| Liners' group | A, B, C |
| Shuttle | S |
| Stations number | 1, 2 . . . 26 |
| Arriving | + |
| Departing | − |
| Passing through | = |

Two Liner Set at FIG. 1
1. A−depot;
2. A=1; B−depot;
3. A+2; B+1;
4. A−2; B−1;
5. A=3; B=2;

The vehicles movement accordingly schedule from #3 through #5 must be repeated until every shown vehicle (A,B) will enter a depot. On step 4 following members can start a similar movement.

Three Liner Set at FIG. 2

1. A−depot;
2. A+1;
3. A−1; B−depot;
4. A=2; B=1; C−depot;
5. A=3; B+2; C=1;
6. A+4; B−2; C=2;
7. A−4; B=3; C+3;
8. A=5; B=4; C−3;

The vehicles movement accordingly schedule from #4 through #7 must be repeated until every shown vehicle (A,B,C) will enter a depot. On step 5 following members can start a similar movement.

Two Liner Set and Shuttle at FIG. 3:

1. A−depot;
2. A=1; B−depot;
3. A+2; B+1;
4. A−2; B−1; S−depot;
5. A=3; B=2; S=1;
6. A+4; B+3; S=2;
7. A−4; B−3; S=2;
8. A=5; B=4; S+3;
9. A+6; B+5; S−3;
10. A−6; B−5; S=4;
11. A=7; B=6; S=5;
12. A+8; B+7; S+6;
13. A−8; B−7; S−6;
14. A=9; B=8; S=7;
15. A+10; B+9; S=7;
16. A−10; B−9; S=8;
17. A=11; B=10; S+9;
18. A+12; B+11; S−9;
19. A−12; B−11; S=10;
20. A=13; B=12; S=11;
21. A+14; B+13; S+12;
22. A−14; B−13; S−12;

The liner vehicles movement accordingly schedule from #3 through #5 must be repeated until every shown vehicle (A,B) will enter a depot. The combine pattern of vehicles movement accordingly schedule from #4 through #22 must be repeated until every shown vehicle (A,B,S) will enter a depot. On step 6 or later, following members can start a similar movement.

Three Liner Sets and Shuttle at FIG. 4:

1. A−depot;
2. A+1;
3. A−1; B−depot;
4. A=2; B=1; C−depot;
5. A=3; B+2; C=1;
6. A+4; B−2; C=2; S−depot;
7. A−4; B=3; C+3; S+1; S−1;
8. A=5; B=4; C−3; S+2; S−2;
9. A=6; B+5; C=4; S+3; S−3;
10. A+7; B−5; C=5; S+4; S−4;
11. A−7; B=6; C+6; S+5; S−5;
12. A=8; B=7; C−6; S+6; S−6;

The liner vehicles movement accordingly schedule from #4 through #7 must be repeated until every shown vehicle (A,B,C) will enter a depot. On step 8 or later, following members can start a similar movement.

Two Liner Set Having a Hub Station at FIG. 5:

1. A−depot;
2. A=1; B−depot;
3. A+2; B+1;
4. A−2; B−1;
5. A+3; B=2;
6. A−3; B+3;

The movement accordingly schedule from #2 through #6 must be repeated until every shown vehicle (A,B) will enter a depot. On step 5, or later, following members can start a similar movement.

Three Liner Set Having a Hub Station at FIG. 6:

1. A−depot;
2. A=1; B−depot;
3. A=2; B+1;
4. A+3; B−1; C−depot;
5. A−3; B=2; C=1;
6. A+4; B=3; C+2;
7. A−4; B+4; C−2;
8. A=5; B−4; C=3;
9. A=6; B+5; C+4;

The movement accordingly schedule from #4 through #9 must be repeated until every shown vehicle (A,B,C) will enter a depot. On step 7, or later, following members can start a similar movement.

1. Method to schedule the attendance of stations constituted the transportation route by passenger vehicles moving in cyclical pattern,
wherein each said station is located at shorter distance from each neighboring said station than length of the run of said transportation vehicles between the neighboring stops on said route and therefore creating ability for passenger entering vehicle of said pattern of movement from each said station on said route using for trip no other transportation media than scheduled accordingly said movement pattern,
therefore run the consequent vehicles on uniform skip-stop movement pattern by alternative in their stop assignments sets through one-way transportation route consisting of station divisions identical in the quantitive content,
wherein having all said stations in each said division attended alternatively by each of said vehicle sets member only one time during each session of said division attendance by each said vehicle to be called “Cycle”,
therefore having said members of sets of vehicle performing each with equality in their movement pattern described in general by standard linear function equation,
wherein vehicles of plural sets providing passenger service to be called “Liners”,
comprising the steps of:
determining quantity of liner sets, constituted the cycle of service vehicles attendance;
determining desirable sequence of liner stops in single group of stations division;
determining stop designations after each liner at first cycle;
continue determining stop designations after each liner at next cycles;
determining all stop designations until the last one on service route after each liner for:
inertia factor to be minimized accordingly decreased demand in serving stops and vehicles' acceleration afterwards and accordingly decreased demand in vehicles quantity or in vehicle physical parameters,
operating costs to be minimized due to inertia factor minimized,
service speed factor to be maximized accordingly decreased demand in vehicles' stops and accordingly longer distance between neighboring stops for service vehicles therefore,
vehicle cumulative capacity factor to be maximized accordingly service speed factor increased,
traveling time cost for passenger to be decreased due to accesability of the transportation vehicle performing with increased speed from every station on transportation route.

2. Method to schedule the passenger vehicles movement of claim 1, wherein two or more groups of vehicle sets assigned to provide passenger service on the same route,
wherein each said group have difference in the quantity of service stations constituting said station divisions accordingly,
therefore one of said groups to be the complete set and to be called “Liners”, and other groups to be incomplete and to be called “Shuttle”,
comprising the steps of:
determining quantity of liner sets, constituted the cycle of stations attendance by service vehicle;
determining desirable sequence of liner stops in single liners' stations division;
determining stop designations after each liner for first cycle;
continue determining stop designations after each liner for next cycles;
determining all stop designations until the last one on service route after each liner;
determining shuttles' quantity in one cycle;
determining desirable sequence of shuttle stops in single shuttle stations division;
determining stop designations after each shuttle for first cycle;
continue determining stop designations after each shuttle for next cycles;
determining all stop designations until the last one on service route after each shuttle for:
inertia factor to be minimized accordingly decreased demand in serving stops and vehicles' acceleration afterwards and accordingly decreased demand in vehicles quantity or in vehicle physical parameters,
operating costs to be minimized due to inertia factor minimized,
service speed factor to be maximized accordingly decreased demand in vehicles' stops and accordingly longer distance between neighboring stops for service vehicles therefore,
vehicle cumulative capacity factor to be maximized accordingly service speed factor increased,
traveling time cost for passenger to be decreased due to accesability of the transportation vehicle performing with increased speed from every station on transportation route.

3. Method to schedule the passenger vehicles movement of claim 1, wherein said station divisions contain one or more additional stations designated as the mutual stops for all said transportation vehicles called “Liners”,
comprising the steps of:
determining quantity of liners sets;
locating the hubs in single stations division;
determining the cycle of stations attendance by service vehicle extended by hubs;
determining desirable sequence of liner stops in extended single stations division;
determining stop designations after each liner at first extended by hubs cycle;
continue determining stop designations after each liner at next extended by hubs cycles;
determining all stop designations until the last one on service route after each liner for:
inertia factor to be minimized accordingly decreased demand in serving stops and vehicles' acceleration afterwards and accordingly decreased demand in vehicles quantity or in vehicle physical parameters,
operating costs to be minimized due to inertia factor minimized,
service speed factor to be maximized accordingly decreased demand in vehicles' stops and accordingly longer distance between neighboring stops for service vehicles therefore,
vehicle cumulative capacity factor to be maximized accordingly service speed factor increased,
traveling time cost for passenger to be decreased due to accesability of the transportation vehicle performing with increased speed from every station on transportation route.
